(19) United States
(12) Patent Application Publication
(10) Pub. No.: US 2011/0168466 A1
(43) Pub. Date: Jul. 14, 2011

(54) HUB WHEEL MOTOR

(76) Inventor: Gary Starr, Santa Rosa, CA (US)

(21) Appl. No.: 12/728,228

(22) Filed: Mar. 21, 2010

Related U.S. Application Data
(60) Provisional application No. 61/295,025, filed on Jan. 14, 2010.

(51) Int. Cl. B60K 1/00

(52) U.S. Cl. 180/65.51

(57) ABSTRACT

A hub motor includes a motor shaft, which is fixed and non-rotational and a rotating wheel hub. The hub includes a plurality of coil windings positioned around the motor shaft; a plurality of magnets positioned around the coil windings; one or more sensors in the wheel hub housing; and a cable to supply power and communicate control signals to a controller.

This application claims priority to Provisional Application Ser. No. 61/295025 filed Jan. 14, 2010, the content of which is incorporated by reference.

### BACKGROUND

Electric motors have been used in the past to operate vehicles such as electrical bicycles. The electric motors of the prior art have been rather large in size and are of relatively heavy weight. It is desirable to have the electric motor to be as small as possible and also to have the motor be as light in weight as possible to thereby keep the overall weight of the vehicle as low as possible.

Electric motors require the use of an electronic controller which controls the different speeds that the motor is being operated. In the past, it has been common to use a controller that is mounted separate from the motor. This requires an additional structure and requires separate mounting in conjunction with a bicycle being preferable to eliminate the use of this separate structure. A conventional hub motor is disclosed in U.S. Pat. No. 6,321,863 and includes an electrical motor received in a hub which is driven by the electrical motor.

United States Patent Application 20050176542 discloses an electrically driven hub with an electrical mechanism including an electrical motor and a planetary gear system connected to the electrical mechanism. A first fixed shaft is connected to the stator of the electrical motor and a second fixed shaft is connected to a second end of the stator of the electrical motor. The first and second fixed shafts are connected to the vehicle frame. A one-way clutch is connected between a cover of the hub and the planetary gear system so that the hub is rotated when the planetary gear system is activated by the motor.

### SUMMARY

A hub motor includes a motor shaft, which is fixed and non-rotational and a rotating wheel hub. The hub includes a plurality of coil windings positioned around the motor shaft; a plurality of magnets positioned around the coil windings; one or more sensors in the wheel hub housing; and a cable to supply power and communicate control signals to a controller.

Implementations of the motor may include one or more of the following. A hub wheel housing can enclose the wheel hub. An electronic controller can drive the coil windings and receive information from the sensors. The electronic controller can control the charging of a rechargeable battery. The electronic controller can be coupled to a motor controller or a brake controller. The electronic controller also receives commands from an operator panel to receive speed and travel direction control. The sensors can be an encoder such as a linear sensor, a capacitive sensor, a Hall-effect encoder or an LED based sensor, among others.

Advantages of the motors may include one or more of the following. The hub wheel motors are lighter and more compact, eliminating the need for a transmission and drive train. The unique design translates to more available space, which can be dedicated to a larger battery for range extension. The motors achieve a far higher horsepower output with just a slight increase in weight and size.

Since major systems are housed within the wheel itself, many core components of a traditional automobile can be removed such as the engine, transmission, clutch, suspension and other related parts because the in-wheel components handle all of these functions. This replacement of mechanical functions with electrical functions can be used as by-wire technology—such as drive-by-wire, or brake—by-wire, for example. The motor reduces carbon emissions and addresses the rising demand for more environmentally sound vehicles such as EVs.

The number of in-wheel motors a vehicle actually uses can be adjusted to meet the vehicle requirements. For instance, in most cases, two motors will supply sufficient power; however, for an all-wheel-drive (AWD) vehicle—either an off-road truck or a performance car—four in-wheel motors can be used.

### BRIEF DESCRIPTION OF THE DRAWINGS

FIGS. 1A-1C show an exemplary car hub wheel motor system.

FIGS. 2A-2B show two exemplary embodiments of the hub motor of FIG. 1.

FIG. 3 shows an exemplary cross-sectional cut-away view of a hub motor.

FIG. 4 shows a side perspective view of a three kilowatt hub wheel motor embodiment without the cap.

FIG. 5 shows a side perspective view of a seven kilowatt hub wheel motor embodiment without the cap.

FIGS. 6-7 show an exemplary motor housing for the motor of FIG. 1.

FIG. 8 show exemplary control electronics.

FIG. 9 shows an exemplary wheel on a hub-wheel motor.

FIG. 10 shows an exemplary bicycle with a hub-wheel motor.

FIG. 11 shows an exemplary electric car with hub-wheel motors.

FIG. 12 shows an exemplary truck with hub-wheel motors.

### DESCRIPTION

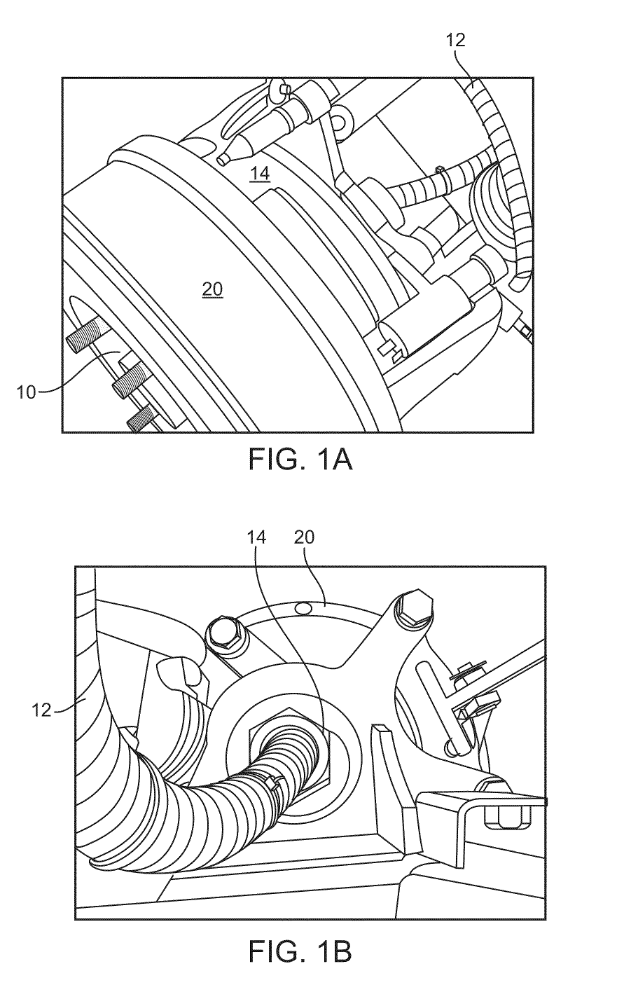

FIGS. 1A-1C show an exemplary hub wheel motor system for a car. The system includes a motor enclosed by a hub cap 10 and a tire supporting rim 20. A rubber wheel can be mounted on the rim 20. The hub cap 10 has an opening through which a cable 12 is inserted therethrough. The cable 12 provides power as well as control signals to the motor. The system also includes a brake disc 15 with twin calipers 17 to provide braking power to the wheel.

The cable 12 passes through the shaft 14 to enter an internal chamber of the motor housing. The cable 12 has a plurality of electrical conducting wires which are connected to electronic components mounted on a printed circuit board. All wires are not shown and the number of the wires will vary based on control functions required. The printed circuit board is then fixedly mounted on a mounting plate in the motor. In one embodiment, the mounting plate is made of heat conductive material like aluminum and is fixedly attached by means of a set screw to the center shaft 14.

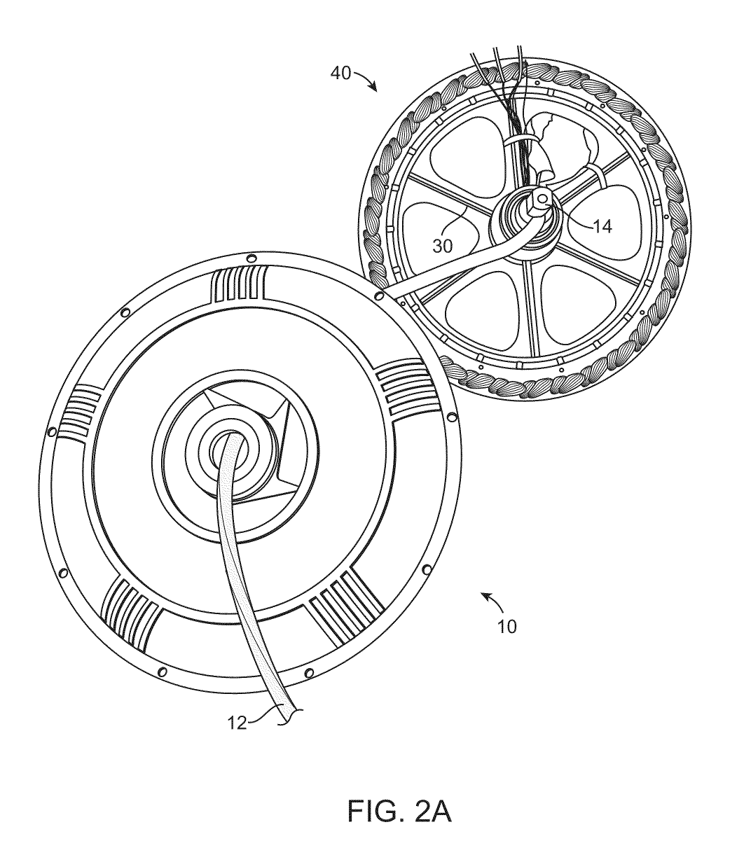

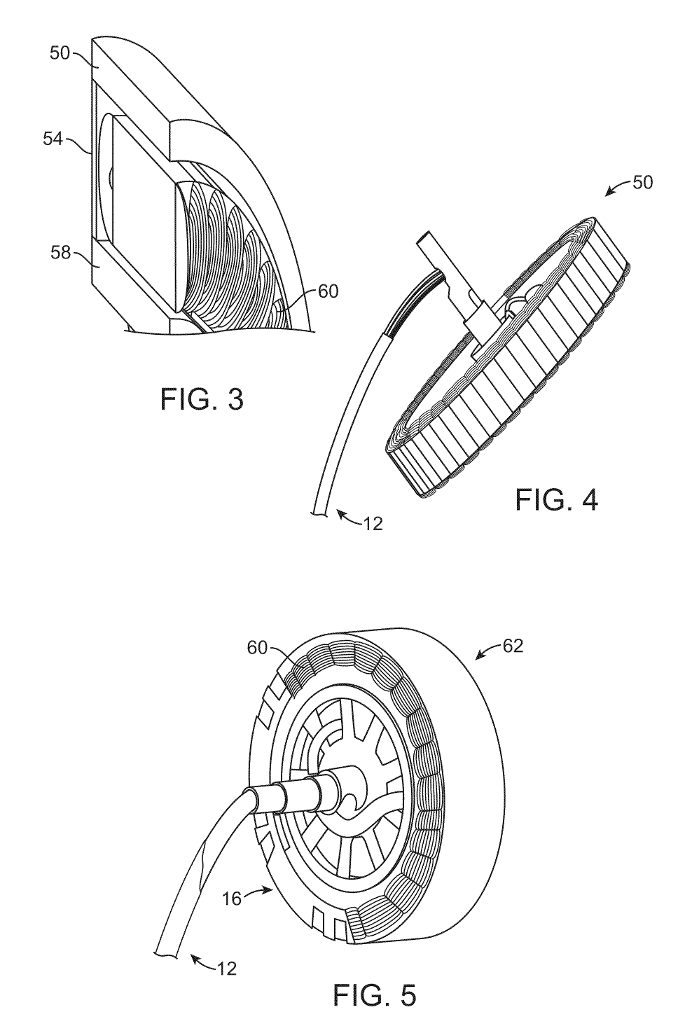

The center shaft 14 is capable of being rotated about rotational axis. It is to be noted that the rotational axis is located parallel to the longitudinal center axis. The locating of the parallel axis provides for smoother operation of the motor. Mounted interiorly of the motor are a series of magnets 50 (FIGS. 3-5). These magnets are located directly adjacent but slightly spaced from a series of radially located coils 40. There are multiple numbers of the coils 40 each of which comprises electrically conductive wires that are wound about a series of radially disposed spokes called stator laminations, which are not shown. The coils 40 are connected by leads to a printed circuit board 16 (FIG. 5).

The outer, ring-shaped permanent magnet 50 (stator) rotates and the inner metallic core (rotor) is fixed. When the motor is switched on, the static rotor stays still while the stator 50 spins around it. A tire is attached to the motor, and as the outer part of the motor rotates, the wheel (or wheels) powers the vehicle forward.

Sensors can be mounted in the hub wheel motor. An encoder such as a linear sensor, a capacitive sensor, a Hall-effect encoder or an LED based sensor can be used. For Hall effect sensors, by sensing the current provided to a load and using the device's applied voltage as a sensor voltage it is possible to determine the power dissipated by the motor. Hall effect devices used in motion sensing and motion limit switches can offer enhanced reliability in extreme environments. As there are no moving parts involved within the sensor or magnet, typical life expectancy is improved compared to traditional electromechanical switches. Additionally, the sensor and magnet may be encapsulated in an appropriate protective material. In one implementation, the Hall effect sensor is used as a direct replacement for the mechanical breaker points used in earlier automotive applications. Its use as an ignition timing device in various distributor types is as follows. A stationary permanent magnet and semiconductor Hall effect chip are mounted next to each other separated by an air gap, forming the Hall effect sensor. A metal rotor consisting of windows and tabs is mounted to a shaft and arranged so that during shaft rotation, the windows and tabs pass through the air gap between the permanent magnet and semiconductor Hall chip. This effectively shields and exposes the Hall chip to the permanent magnet's field respective to whether a tab or window is passing though the Hall sensor. For ignition timing purposes, the metal rotor will have a number of equal-sized tabs and windows matching the number of engine cylinders. This produces a uniform square wave output since the on/off (shielding and exposure) time is equal. This signal is used by the engine computer or ECU to control ignition timing. It is worth noting that many automotive Hall effect sensors have a built-in internal NPN transistor with an open collector and grounded emitter, meaning that rather than a voltage being produced at the Hall sensor signal output wire, the transistor is turned on providing a circuit to ground though the signal output wire.

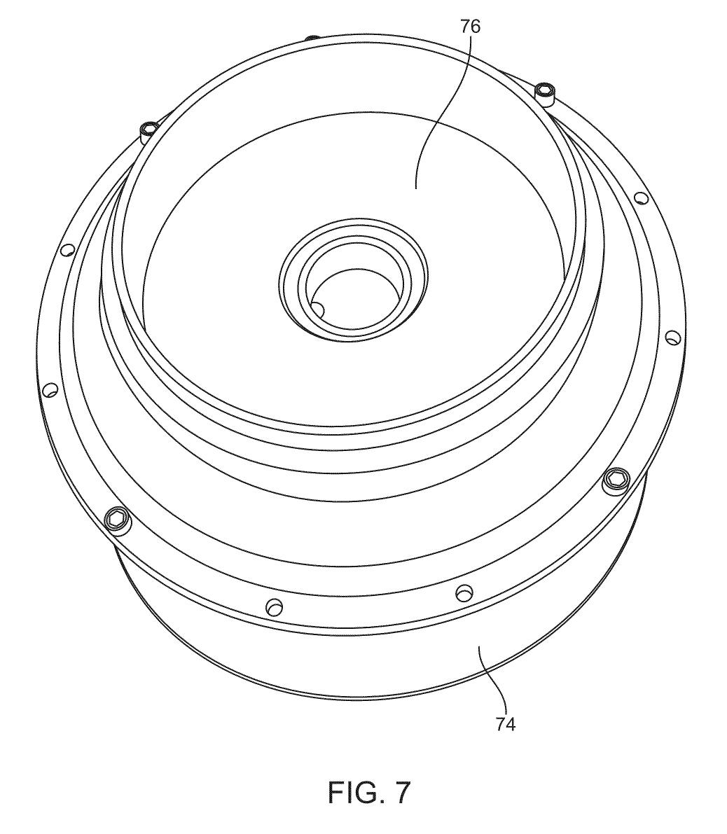

In one embodiment, a position sensor can be provided and a signal can be transmitted through the cable 12 to an external controller for providing positional feedback. The sensing of wheel rotation is especially useful in anti-lock brake systems. A controller 114 (FIG. 8) can provide anti-skid functions for extended vehicle handling enhancements.

The controller 114 (FIG. 8) can also control the motor of FIG. 1 to provide power regeneration. In one embodiment, a regenerative brake control circuit uses a chopper circuit which is first closed thereby to form a closed loop comprising at least a motor, a reactor and a chopper. The motor is used as a generator during the braking operation and therefore a current generated by the motor flows in the closed loop thereby to store electromagnetic energy in the reactor. A voltage drop in the chopper and other junction points is so small that the voltage across the reactor is substantially equal to the voltage generated by the motor. Next, the chopper is opened to thereby connect the series-connected motor and reactor to power source. The voltage across the motor and the reactor becomes higher than the source voltage and power is returned to the power source. With the decrease in the energy stored in the reactor, the voltage across the series-connected motor and reactor drops, and when it is decreased to a level lower than the source voltage, the current flowing to the power source is reduced accordingly to zero. By closing again the chopper circuit after the decrease of the current to the power source, the motor current is increased to thereby raise the voltage across the reactor again. Then, again connecting the motor circuit to the power source, a reverse current again flow to the power source. With repetition of the above process the motor current, that is, regenerative brake current can be controlled.

The system includes a rubber tire (not shown) which is mounted on a tire supporting rim 20. The tire supporting rim 20 is connected to a series of mechanical spokes 30. The inner end of the spokes 30 are attached to annular flange of a motor housing. In one embodiment, fixedly mounted between the fork members of the vehicle frame is a center shaft 14. The ends of the center shaft 14 are threaded with a nut being used to fixedly mount the center shaft 14 to the fork member of the vehicle and a nut can be used to fixedly secure the center shaft 14 to the fork member. Mounted on the center shaft 14 are a pair of spaced apart bearing assemblies(not shown). A motor housing is rotationally mounted on the bearing assembly. The motor housing includes a removable access plate which is bolted to housing by bolt fasteners.

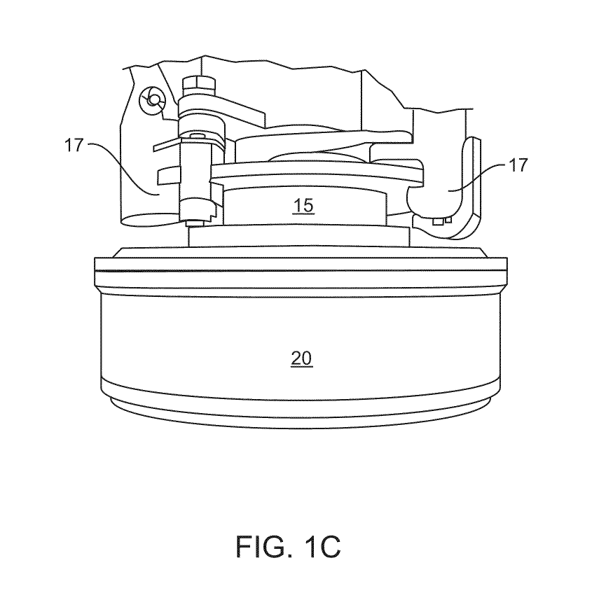

FIGS. 2A-2B show two exemplary embodiments of the hub motor of FIG. 1, which in this case is for an electric bike or motorcycle. However, the structure is similar to a car hub wheel motor, but can be made for low power since the load is smaller than a car load on the motor.

The cable 12 is threaded through the hub cap 10 into a motor spindle or drive shaft 14. The motor spindle is supported by a frame 30 that can be aluminum or other suitable high strength materials. The frame 30 is circular in shape, and can have alternating cut-out regions to reduce material cost and weight while maintaining structural strength. A series of coils 40 is positioned on the perimeter of the frame 30. A series of magnets 50 surround the coils 40 at the outer perimeter of the motor assembly.

FIG. 3 shows an exemplary cross-sectional cut-away view of a hub motor. As shown in FIG. 3, the magnet 50 surrounds a series of coiled loops 60 forming an electro-magnet in region 54. The coiled loops 60 is bordered at the bottom by a support 58.

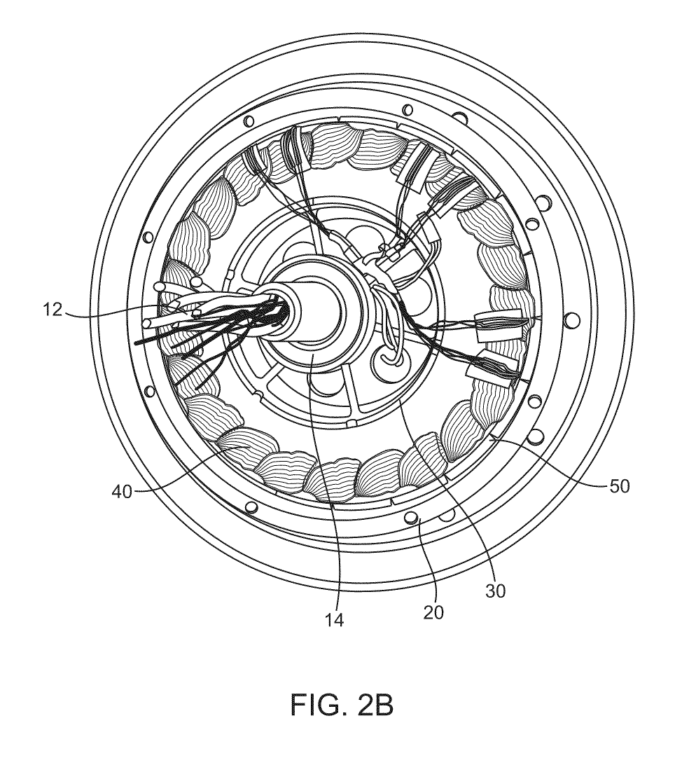

FIG. 4 shows a side perspective view of a three kilowatt hub wheel motor embodiment without the cap or face plate. FIG. 5 shows a side perspective view of a seven kilowatt hub wheel motor embodiment without the cap. Coils 60 are thicker than coils of FIG. 4, and magnets 62 are larger and more powerful than the magnets of FIG. 4 to provide more torque power to the motor for driving large loads such as cars and other heavy vehicles.

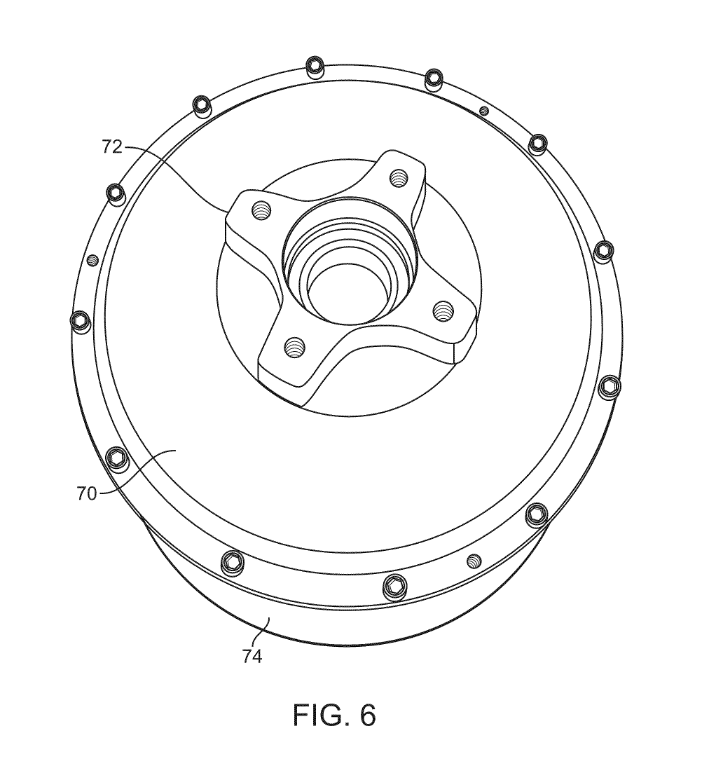

FIGS. 6-7 show an exemplary motor housing that can be used with the motor of FIG. 1. In FIG. 6, a plurality of housing mounts 72 are provided to secure the housing to a vehicle such as a car. A face plate 70 is provided and a motor chamber 74 extends behind the face plate 70 to house the motor. As shown in FIG. 7, the hub motor is contained in a chamber 76.

In one embodiment, the brake is positioned behind the hub wheel motor/tire to provide braking functions. Two major types of brakes can be used with the hub motor: the disc brake and the drum brake. A drum brake generally includes a drum having a cylindrical outer wall which surrounds a pair of brake shoes controlled by a brake cylinder which force the brake shoes outwards to contact the inner or braking wall of the drum, thus slowing and eventually stopping the rotation of the drum due to the frictional contact between the brake shoes and the braking wall of the drum. The drum brake for a car can be controlled by a brake pedal with a brake plate and a brake drum. Two brake shoes and a cylinder actuated by hydraulic oil on depression of the brake pedal are mounted on an inner side of the brake plate. A first brake lining is mounted on the brake shoe for engaging with an inner surface of the brake drum to provide the brake effect. The drum brake can provide an additional brake lining around an outer surface of the brake drum together with an additional brake pedal installed proximate to the clutch pedal to aid in shortening the stopping distance of a car.

A disc brake 15 can also operate with the motor of FIG. 1. The brake is made up with a disc or a flattened circular crown integral with the wheel and nippers located on the disc. The nippers are fitted for pressing two pads on opposing sides of the disc flat surface. Friction between a moving disc and the pads converts the disc kinematic energy into heat and the desired braking effect is thus achieved. In one embodiment, the disc brake provides both a normal service brake, that is, the hydraulically actuated brake used to stop a vehicle, and a manual system, either for emergency or parking brake functions. The service brake is hydraulically actuated from a conventional automotive master cylinder plumbed to an hydraulic cylinder incorporated in the brake. The brake can also be actuated manually, independently of the hydraulic system, by lever or pedal structure remotely attached on the brake. This manual structure may be either for emergency situations or for parking.

Brake actuation is provided by hydraulically or manually rotating a central plate which, through a roller/ramp structure, moves a piston structure to engage both halves of the brake simultaneously, the brake incorporating two separate stacks of brake discs. The roller/ramp structure attenuates the hydraulic or manual force required to actuate the brake and, in effect, makes the brake operate as a self-contained power brake which may eliminate the need for a vacuum or power assist at the master cylinder. The pistons, rollers and central plate are held together by springs which return the pistons to a neutral position when hydraulic pressure or manual force is released. A roller/ramp structure is incorporated rather than a ball/ramp structure. This results in greatly reducing component stresses and simplifying machining.

The block diagram of FIG. 8 includes an operator's panel 112 for speed and direction control, an electronic drive and brake controller 114, and a rechargeable battery 116. The drive and brake electronic controller in turn controls the electric motor of FIG. 1.

In an embodiment, the invention provides a regenerative braking system for an electric vehicle having front and rear wheels, and includes a drive wheel, an actuating device, a regenerative braking control circuit, and a power electronics circuit. The regenerative braking control circuit includes a transducer, such as a potentiometer or digital encoder or the like, a process sensor, and a microprocessor. The power electronics circuit includes a rechargeable electric power source, an electric motor, and a motor controller. The actuating device is coupled to the transducer. The transducer and process sensors signal the microprocessor which applies an algorithm to the signals and produces an output signal to the motor controller for regulating a regenerative braking torque to the drive wheel. The algorithm includes a subroutine for preventing lock-up of the drive wheel. In one embodiment, the regenerative braking system is independent of a vehicle friction brake system. In another embodiment, the regenerative braking system cooperates with a friction brake system.

In the embodiment, the braking system applies a regenerative braking torque to the drive wheel when the operator panel 112 signals a regenerative braking command, and the sensors signal a drive wheel velocity greater than zero. Preferably, the braking torque increases with an increase in the sensor signal as controlled by the operator, and the subroutine adjusts the braking torque when an anti-lock trigger is activated. In essence, during the regenerative braking mode, the motor act as a generator supplying current to the battery which loads down the generator, thereby causing a braking action.

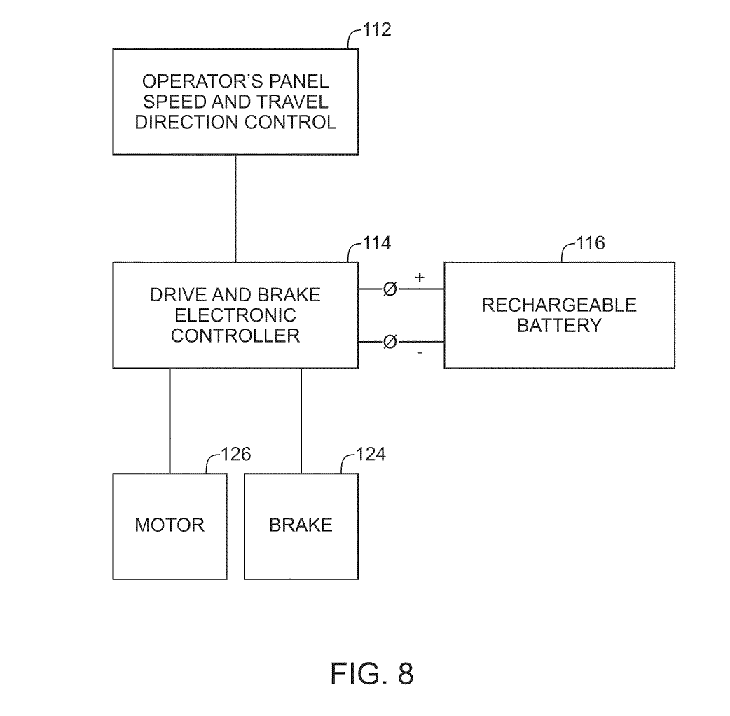

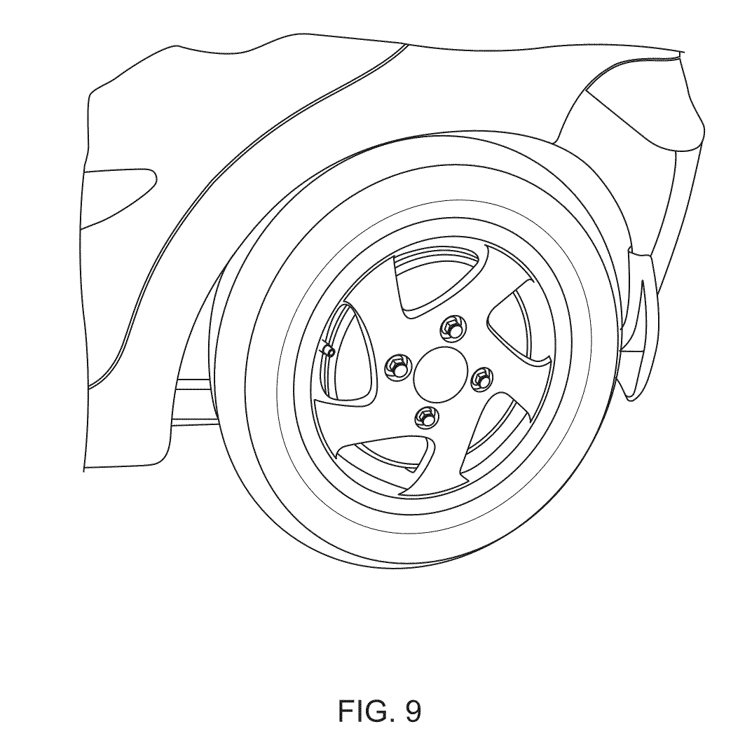

The operation of the hub motor assembly of this invention is as follows: When the driver wishes to drive the vehicle such as a car (FIG. 9) or a bicycle (FIG. 10) by means of electrical power, the user manually moves a switch from the off position to the on position. This will result in electrical power from the battery 116 being supplied through the cable 12 to the printed circuit board 16 and then through lead wires to the coils 40. This will cause the rotor to be rotated due to the forming of a magnetic field between the coils 40 and the magnets 50. This rotation of the rotor will cause the rotor bushing to rotate which rotates the drive shaft 14. The rotation of the drive shaft 14 will cause the driven gear to be rotated. A gear reduction or increase can be used so that the motor housing will be rotated at a substantial number of less or more revolutions per minute than the drive shaft 14.

FIG. 9 shows the hub wheel motor used in a car vehicle. The hub motor of FIG. 1 is designed to be small in size. The compact motor assembly is mounted in conjunction with the hub of the car. The motor assembly includes a self contained unit which includes a rotationally driven motor housing that is connected directly to the tire supporting rim of the car wheel. Rotation of the motor housing will result in similar rotation of the tire supporting rim of the wheel. The motor housing has an internal chamber and within that internal chamber is located a stator and a rotor. The stator is fixedly mounted onto a center shaft which passes through the motor housing which is fixedly mounted to the car. The rotor is to be rotated by the electrical energy being supplied to the stator with this rotation being transferred through the drive shaft.

FIG. 10 shows a bicycle which has a tubular frame upon which is mounted a foot operational pedal assembly, a front wheel and two rear wheels. The frame includes a handlebar assembly on which is mounted an electrical switch. The electrical switch is connected by a conductor to a battery. The battery is connected by a cable to the hub motor assembly of FIG. 1. The hub motor assembly is shown mounted in conjunction with the front wheel. However, the hub motor assembly could be mounted in conjunction with the rear wheel as well.

Although the hub motor of the present invention has been found to have particular utility in conjunction with electrically operated bicycles, the motor is also deemed to have utility of other applications such as operating of a scooter, moped, tricycle, wheelchair and other types of manually operated wheeled vehicles as well as within other environments not discussed herein.

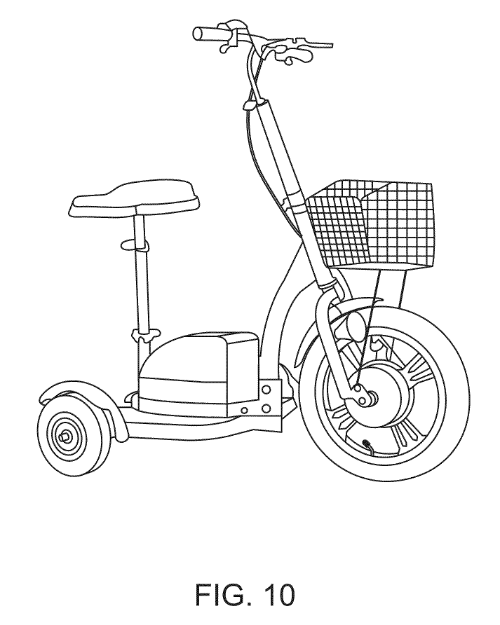

FIG. 11 shows an exemplary electric car with hub-wheel motors. The vehicle is called Alias, available from ZAP, Inc. of Santa Rosa, Calif. The Alias is 100% electric, 100% of the time. Recharging is simple and effortless via any 110V outlet at home or on the road. The Alias has aerodynamic contours, low profile, wide stance with double-wishbone suspension, and sport styling.

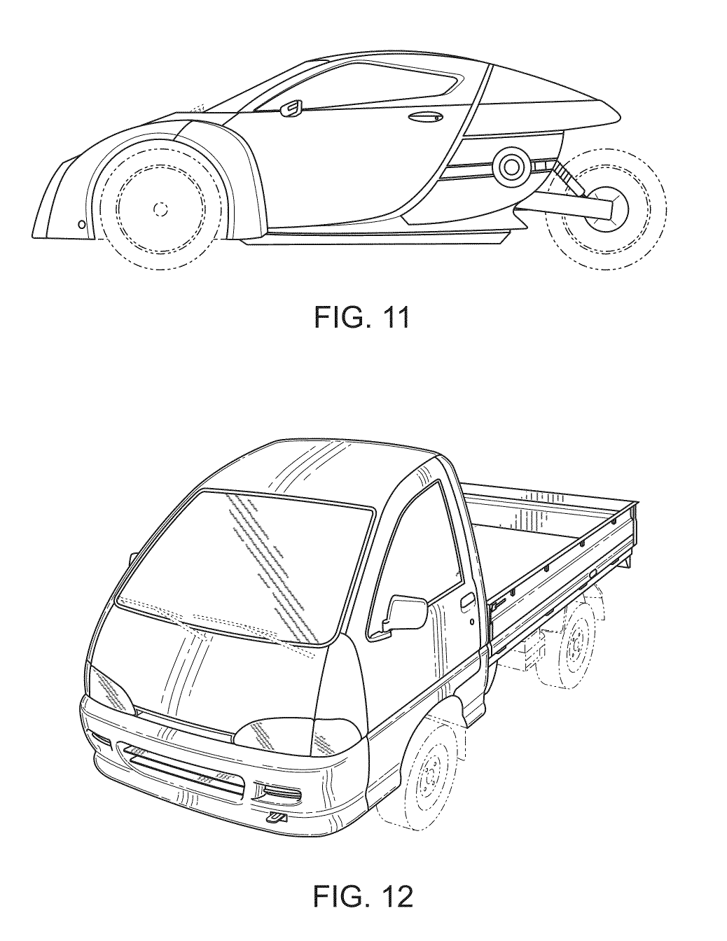

FIG. 12 shows an exemplary truck with hub-wheel motors called ZAP Truck XL. Roomy, durable, rugged yet whisper quiet, the ZAPTRUCK XL is the affordable green solution for fleet operations. The electric truck is a utilitarian workhorse providing a roomy cab for two and a convertible bed/platform for moving up to 1600 lbs. of cargo during off-road use. The vehicle is ideal for corporate campuses, warehouses, universities, factories, municipal operations and around the ranch or farm.

In one embodiment, a tire containing a sensor monitors the inflation pressure and in contact with the road. The hub wheel motors will take over the task of ensuring contact between wheel and road. With this suspension, hydraulic steering can be eliminated, giving automakers new degrees of freedom. Each individual wheel can be moved to its own specific steering angle. When the speed is reduced, the wheel hub motors act as auxiliary brakes using a generator effect. The energy reclaimed in this manner can be used to charge the vehicle battery. In addition to the generator brakes, an electronic wedge brakes (EWB) can be used in one embodiment to decelerate each wheel separately with maximum precision and enormous braking power to match the need of the driving situation.

The wheel hub motor provides energy efficiency and the associated emissions. Under optimum conditions, a full hybrid system utilizes approximately 85 percent of the theoretically available energy. Today's gasoline and diesel engines is even less than 50 percent. Wheel hub motors can use up to 96 percent of the provided electrical energy for vehicle propulsion. This will make it much easier for automobile manufacturers to satisfy emission regulations and while simultaneously offering extremely dynamic vehicles with excellent fuel economy.

Integration of various vehicle components into the wheels allows further modularization of the cars: Vehicle manufacturers only will require different drive wheel layouts for equipping highly differing vehicle concepts.

In one embodiment, hub wheel motor cars can be parked sideways using pivoting wheels or electronic steering aids and controlled acceleration of individual wheels for better vehicle stabilization in hazardous situations. Finally the costs for car owners will also be reduced: Fewer components and elimination of the hydraulic systems will reduce wear and service complexity.

The software controlling the motor can be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The system has been described in terms of specific examples which are illustrative only and are not to be construed as limiting. In addition to control or embedded system software, the system may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

What is claimed is:

1. A hub motor comprising:
a motor shaft, which is fixedly mounted to a car and non-rotational;
a rotating car wheel hub, including:
a plurality of coil windings positioned around the motor shaft;
a plurality of magnets positioned around the coil windings;
one or more sensors in the wheel hub housing; and
a cable to supply power and communicate control signals to a controller.

2. The hub motor as set forth in claim 1, comprising a hub wheel housing to enclose the wheel hub.

3. The hub motor as set forth in claim 1, comprising an electronic controller coupled to the coil windings and to the sensors.

4. The hub motor as set forth in claim 3, wherein the electronic controller is coupled to a rechargeable battery.

5. The hub motor as set forth in claim 3, wherein the electronic controller is coupled to a motor controller.

6. The hub motor as set forth in claim 3, wherein the electronic controller is coupled to a brake controller.

7. The hub motor as set forth in claim 3, wherein the electronic controller is coupled to an operator panel to receive speed and travel direction control.

8. A vehicle comprising the hub motor of claim 1.

9. A vehicle comprising the hub motor of claim 2.

10. A vehicle comprising the hub motor of claim 3.

11. A vehicle comprising the hub motor of claim 4.

12. A vehicle comprising the hub motor of claim 5.

13. A vehicle comprising the hub motor of claim 6.

14. A vehicle comprising the hub motor of claim 7.

15. A device comprising the hub motor of claim 1.

16. The device of claim 15, comprising a light vehicle frame coupled to the hub motor.

17. The device of claim 15, comprising a position sensor.

18. The device of claim 17, wherein the position sensor comprises a linear encoder.

19. The device of claim 15, comprising a power sensor.

20. The device of claim 15, comprising a Hall-effect sensor.
